(19) United States
(12) Patent Application Publication
(10) Pub. No.: US 2021/0003749 A1
(43) Pub. Date: Jan. 7, 2021

(54) LENS MODULE

(71) Applicant: AAC Optics Solutions Pte. Ltd., Singapore city (SG)

(72) Inventor: Chuandong Wei, Shenzhen (CN)

(21) Appl. No.: 16/916,148

(22) Filed: Jun. 30, 2020

(30) Foreign Application Priority Data
Jul. 3, 2019 (CN) PCT/CN2019/094606

(51) Int. Cl. G02B 5/00; G02B 7/02; G02B 13/18

(52) U.S. Cl. CPC G02B 5/003; G02B 13/18; G02B 7/021

(57) ABSTRACT

The present disclosure provides a lens module including a lens barrel and a lens group accommodated in the lens barrel. The lens barrel comprises a barrel wall, and the barrel wall comprises an object side surface adjacent to an object side, an image side surface adjacent to an image side and a connection surface connecting the object side surface and the image side surface. The object side surface includes a flat surface and an inclined surface extending from the flat surface slantingly in a direction toward the image side to the connection surface. A light shielding member is provided between the barrel wall and the first lens. A light through hole structure compatible with the ultra-wide-angle lens is formed, stray light is reduced without blocking the light of a large field of view, and shaping of the lens module is made to be easy.

### TECHNICAL FIELD

The present disclosure relates to the field of optical technology, in particular to a lens module.

### BACKGROUND

With the increasing maturity of optical imaging technology, various imaging products such as cameras, video cameras and telescopes are popularized in thousands of households, and portable electronic devices such as tablet computers, mobile phones and the like are also equipped with lens modules. The design of lens module is always the key to the imaging quality of such products. However, due to the improper design of the light through hole structure of the lens barrel in the current lens module, the lens barrel is likely to limit the light of the large field of view and affect shaping of the lens, and thus cannot be applied to the ultra-wide-angle lens.

Therefore, it is necessary to provide a new type of lens module to constitute a suitable light through hole structure for the ultra-wide-angle lens.

### SUMMARY

An objective of the present disclosure is to provide a lens module which is able to reduce stray light without blocking the light of a large field of view and is easy to be shaped.

The technical solution of the present disclosure is as follows.

A lens module is provided including a lens barrel and a lens group accommodated in the lens barrel. The lens barrel includes a barrel wall defining a light through hole, and the barrel wall includes an object side surface adjacent to an object side of the lens module, an image side surface adjacent to an image side of the lens module and a connection surface connecting the object side surface and the image side surface. The lens group includes a first lens adjacent to the object side, the first lens includes an upper surface adjacent to the object side, and the upper surface includes an arc-shaped portion and a peripheral portion provided around the arc-shaped portion. The object side surface includes a flat surface and an inclined surface extending from the flat surface slantingly in a direction toward the image side to the connection surface. The connection surface extends from the inclined surface slantingly in a direction away from an optical axis of the lens module to the image side surface. The connection surface and the arc-shaped portion are spaced apart from each other, and a light shielding member is provided between the barrel wall and the first lens.

As an improvement, the light shielding member is a light shielding layer provided on the upper surface, and the light shielding layer is located between the connection surface and the upper surface and is formed by ink penetration.

As an improvement, the light shielding layer is a black ink layer.

As an improvement, the light shielding layer has a hollow ring structure.

As an improvement, both the connection surface and the upper surface are processed by extinction treatment, and at least one of the connection surface and the upper surface is provided with a flow guiding notch for the ink.

As an improvement, on a cross section where the optical axis is located, a first included angle θ₁ is defined between the inclined surface and the optical axis, and the first included angle θ₁ meets a condition of 30°≤θ₁≤90°.

As an improvement, on the cross section where the optical axis is located, a second included angle θ₂ is defined between the connection surface and the optical axis, and the second included angle θ₂ meets a condition of 0°≤θ₂≤60°.

As an improvement, the image side surface is a flat surface.

As an improvement, the image side surface abuts against the upper surface.

As an improvement, the lens module further includes at least one second lens provided on the image side of the lens module.

The beneficial effects of the light shielding structure provided by the present disclosure is as follows. A lens module is provided including a lens barrel and a lens group accommodated in the lens barrel. The lens barrel includes a barrel wall defining a light through hole, and the barrel wall includes an object side surface adjacent to an object side of the lens module, an image side surface adjacent to an image side of the lens module and a connection surface connecting the object side surface and the image side surface. The lens group includes a first lens adjacent to the object side, the first lens includes an upper surface adjacent to the object side, and the upper surface includes an arc-shaped portion and a peripheral portion provided around the arc-shaped portion. The object side surface includes a flat surface and an inclined surface extending from the flat surface slantingly in a direction toward the image side to the connection surface. The connection surface extends from the inclined surface slantingly in a direction away from an optical axis of the lens module to the image side surface. The connection surface and the arc-shaped portion are spaced apart from each other, and a light shielding member is provided between the barrel wall and the first lens. The inclined surface and light shielding member are provided to facilitate formation of a reasonable light through hole structure that is compatible with the ultra-wide-angle lens, such that stray light is reduced without blocking the light of a large field of view, and shaping of the lens module 100 is made to be easy.

### BRIEF DESCRIPTION OF THE DRAWINGS

FIG. 1 is a sectional structural view of a lens module provided by the present disclosure;

FIG. 2 is a sectional structural view of a lens barrel provided by the present disclosure;

FIG. 3 is a sectional structural view of a lens group provided by the present disclosure.

### DETAILED DESCRIPTION

The present disclosure will be further described below with reference to the accompanying drawings and embodiments.

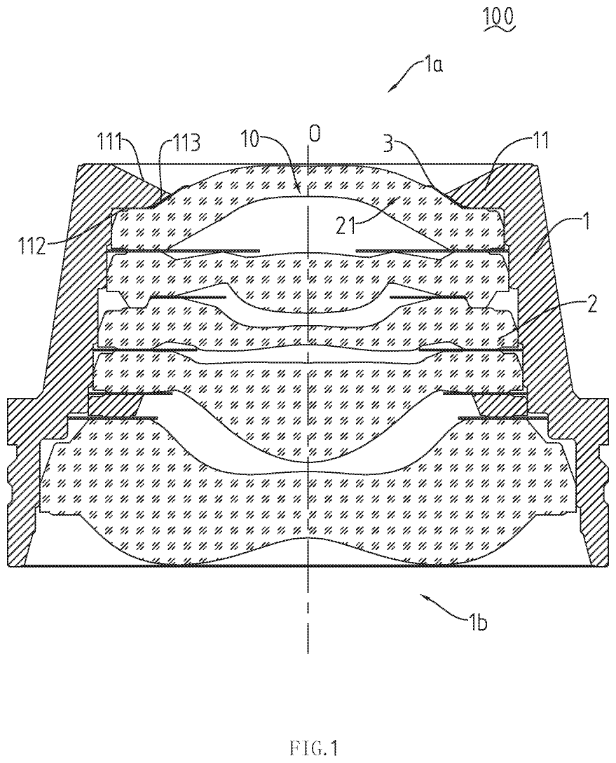

The present disclosure discloses a lens module 100 (as shown in FIG. 1 to FIG. 3) which includes a lens barrel 1 and a lens group 2 accommodated in the lens barrel 1. The lens barrel 1 includes a barrel wall 11 which defines a light through hole 10, and the barrel wall 11 includes an object side surface 111 adjacent to an object side 1a, an image side surface 112 adjacent to an image side 1b, and a connection surface 113 connecting the object side surface 111 and the image side surface 112. The lens group 2 includes a first lens 21 adjacent to the object side 1a, and the first lens 21 includes an upper surface 211 adjacent to the object side 1a. The upper surface 211 includes an arc-shaped portion 211a and a peripheral portion 211b provided around the arc-shaped portion 211a. The object side surface 111 includes a flat surface 111a and a inclined surface 111b, the inclined surface 111b extends from the flat surface 111a slantingly in a direction toward the image side 1b to the connection surface 113. The connection surface 113 extends from the inclined surface 111b slantingly in a direction away from an optical axis O to the image side surface 112. The connection surface 113 and the arc-shaped portion 211a are spaced apart from each other. A light shielding member is provided between the barrel wall 11 and the first lens 21.

With such arrangement, when the light is reflected to the portion where the barrel wall 11 contacts the first lens 21, the light shielding member may absorb the light, thereby preventing the light from continuing to propagate in the lens group 2, and reducing the stray light generated in the lens group 2, that is, reducing the stray light generated in the lens module 100. Compared with the existing technology, the lens module 100 provided by the embodiments of the present disclosure may prevent the incident light to the lens barrel 1 from being reflected to the first lens 21 to form stray light. In this way, the stray light is reduced without blocking the light of the large field of view, and shaping of the lens module 100 is made to be easy.

Further, the light shielding member is a light shielding layer 3 provided between the connection surface 113 and the upper surface 211 and formed by ink penetration. It is known that the light shielding layer 3 is formed by ink penetration, and the color of the ink may be selected according to the different characteristics of the ink in absorbing light. In this embodiment, the light shielding layer 3 is preferably provided as a black ink layer. On the one hand, the black ink layer has better light absorption capability than the ink layers in other colors. On the other hand, since the black ink layer is mainly composed by carbon which has strong adhesion, the black ink layer has a higher degree of adhesion to the connection surface 113 and the upper surface 211. The black ink layer is formed after the black ink penetrates and solidifies. During the formation of the black ink layer, the black ink may diffuse and flow into the space between the connection surface 113 and the upper surface 211 under the physical phenomenon named Brownian motion, so as to form a black ink layer.

As an improvement, the light shielding layer 3 has a hollow ring structure. As an improvement, both the connection surface 113 and the upper surface 211 are processed by extinction treatment, such that extinction effect of the connection surface 113 and the upper surface 211 may be enhanced. In one embodiment, the extinction treatment may be achieved by increasing the roughness of the connection surface 113 and the upper surface 211. When the black ink flows between the connection surface 113 and the upper surface 211 in the manner of molecular diffusion, in order to prevent the ink dripping between the connection surface 113 and the upper surface 211 from flowing into some parts elsewhere, preferably, at least one of the connection surface 113 and the upper surface 211 is provided with a flow guiding notch (not shown) for the dripping ink.

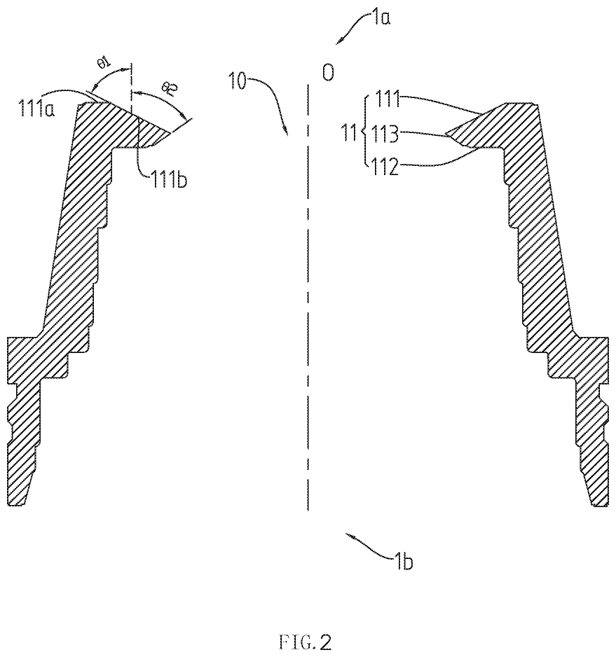

In one embodiment, referring to FIG. 2, on a cross section where the optical axis O is located, a first included angle θ₁ is defined between the inclined surface 111b and the optical axis O, and the first included angle θ₁ meets a condition of 30°≤θ₁≤90°.

In one embodiment, further referring to FIG. 2, on the cross section where the optical axis O is located, a second included angle θ₂ is defined between the connection surface 113 and the optical axis O, and the second included angle θ₂ meets a condition of 0°≤θ₂≤60°.

In this embodiment, the lens module 100 is easy to be shaped with adjustment of the degrees of the first included angle θ₁ and the second included angle θ₂, and meanwhile the requirement for reducing stray light without blocking the light of a large field of view is meet.

In one embodiment, the image side 112 is a flat surface and abuts against the upper surface 211. It can be seen from FIG. 1 and FIG. 2 that the image side surface 112 and the peripheral portion 211b of the upper surface 211 fit without a gap.

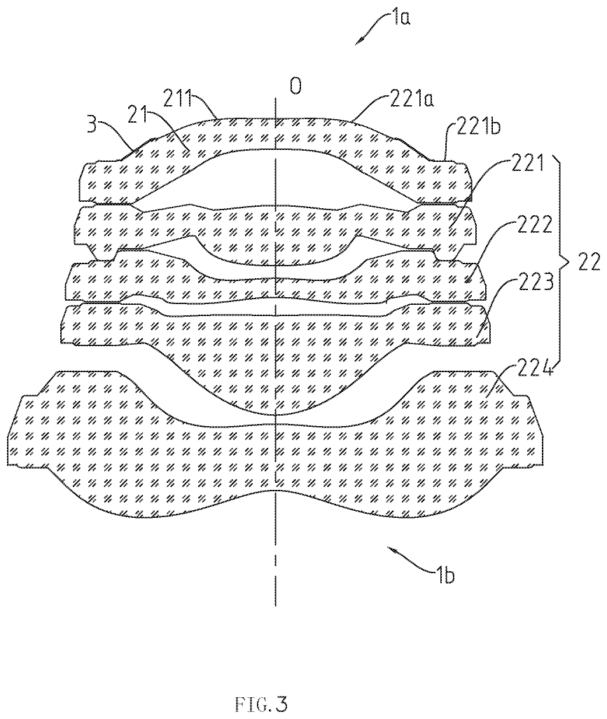

In one embodiment, referring to FIG. 3, the lens module 100 further includes at least one second lens 22 provided on the image side 1b of lens module 100, and may specifically include a lens 221, a lens 222, a lens 223, and a lens 224.

It should be noted that the terms “first” and “second” are merely for descriptive purposes, and cannot be understood as indicating or implying relative importance or implicitly indicating the number of technical features indicated. Thus, the features defined with “first” or “second” may explicitly or implicitly include one or more of the features. The terms “include(s)” and “is(are) provided with” and any variations thereof in the embodiments herein are intended to cover non-exclusive inclusions.

The above-described are merely the embodiments of the present disclosure. It should be appreciated that those skilled in the art may make improvements without departing from the inventive concept of the present disclosure, such improvements, however, fall within the protection scope of the present disclosure.

What is claimed is:

1. A lens module, comprising a lens barrel and a lens group accommodated in the lens barrel, wherein the lens barrel comprises a barrel wall defining a light through hole, and the barrel wall comprises an object side surface adjacent to an object side of the lens module, an image side surface adjacent to an image side of the lens module and a connection surface connecting the object side surface and the image side surface; wherein the lens group comprises a first lens adjacent to the object side, the first lens comprises an upper surface adjacent to the object side, and the upper surface comprises an arc-shaped portion and a peripheral portion provided around the arc-shaped portion; wherein the object side surface includes a flat surface and an inclined surface extending from the flat surface slantingly in a direction toward the image side to the connection surface, the connection surface extends from the inclined surface slantingly in a direction away from an optical axis of the lens module to the image side surface, the connection surface and the arc-shaped portion are spaced apart from each other, and a light shielding member is provided between the barrel wall and the first lens.

2. The lens module according to claim 1, wherein the light shielding member is a light shielding layer provided on the upper surface, and the light shielding layer is located between the connection surface and the upper surface and is form by ink penetration.

3. The lens module according to claim 2, wherein the light shielding layer is a black ink layer.

4. The lens module according to claim 2, wherein the light shielding layer has a hollow ring structure.

5. The lens module according to claim 2, wherein both the connection surface and the upper surface are processed by extinction treatment, and at least one of the connection surface and the upper surface is provided with a flow guiding notch for the ink.

6. The lens module according to claim 1, wherein, on a cross section where the optical axis is located, a first included angle θ₁ is defined between the inclined surface and the optical axis, and the first included angle θ₁ meets a condition of 30°≤θ₁≤90°.

7. The lens module according to claim 6, wherein, on the cross section where the optical axis is located, a second included angle θ₂ is defined between the connection surface and the optical axis, and the second included angle θ₂ meets a condition of 0°≤θ₂≤60°.

8. The lens module according to claim 6, wherein the image side surface is a flat surface.

9. The lens module according to claim 8, wherein the image side surface abuts against the upper surface.

10. The lens module according to claim 1, wherein the lens module further comprises at least one second lens provided on the image side of the lens module.
